(19) United States
(12) Patent Application Publication
(10) Pub. No.: US 2009/0216795 A1
(43) Pub. Date: Aug. 27, 2009

(54) SYSTEM AND METHOD FOR DETECTING AND BLOCKING PHISHING ATTACKS

(76) Inventors: Ram COHEN, Tel Aviv (IL); Aryeh Mergi, Bazra (IL)

Correspondence Address: STITES & HARBISON PLLC, 1199 NORTH FAIRFAX STREET, SUITE 900, ALEXANDRIA, VA, 22314, US

(21) Appl. No.: 12/389,557

(22) Filed: Feb. 20, 2009

(30) Foreign Application Priority Data
Feb. 21, 2008 (IL) 189654

(51) Int. Cl. G06F 17/30

(52) U.S. Cl. 707/102; 707/100; 707/E17.005; 726/5

(57) ABSTRACT

A system and associated method for preventing at least one credential from being submitted to an unauthorized web location. The system comprises 1) a credential blocker for communicating with a database, and 2) the database for storing the at least one credential and an associated set of approved URLs. The credential blocker allows submission of the at least one credential only if at least one URL involved with the submission is a member of the associated set.

### FIELD OF THE INVENTION

The present invention relates to the field of internet security. More particularly, the invention relates to a method and system for detecting and blocking phishing attacks.

### BACKGROUND OF THE INVENTION

Internet banking and commerce depends upon the secure communication of information over the web. In order to carry out a transaction securely, a user generally needs to submit personal information, known hereinafter as credentials, to a remote website. Certain credentials, such as usernames, passwords or the like, may be used in order to identify the user. Other credentials, such as credit card numbers, account numbers or the like, provide details of the means for effecting an internet transaction.

In order to prevent internet fraud, credentials should be kept private. Hackers may attempt to obtain credentials by a technique known as phishing, as described below. The blocking of phishing scams is thus an important element of internet security.

To effect a transaction, credentials may be submitted to an internet location via a web form or the like. Web forms are downloaded from a website by a communication device, such as a computer, mobile phone or the like, connected to the internet. PRIOR ART FIG. 1A schematically shows how a simple web form of the art may be accessed using a computer 10 running a web browser.

The screen 11 of the computer 10 displays the user interface (UI) of the web browser 12, and typically includes an address bar 14 and a viewing pane 16. The browser is configured to download a file 22 from a web location 32, identified by a URL (Uniform Resource Locator), which is entered into the address bar 14. The web location 32 of the example is associated with a bank's website 30 and is located by the URL 15: ‘http://www.thebank.co.uk/login.asp’. This URL 15 is referred to herein as the Source-URL. The browser downloads the file 22 from the Source-URL 15 and uses it to construct a web page, including the web form, for displaying in the viewing pane 16.

More complex web pages may be constructed from several files, each with its own web location and unique Source-URL which may or may not be part of the same domain. In such a case the Source-URL of the form may be different from the URL that is displayed in the address bar 14.

In FIG. 1A, a simple example of a web page including a form 13 is displayed in the browser's viewing pane 16. The web page is constructed from the file 22 downloaded from the web location 32. The file 22 of the example includes the following HTML code:

<html>
<body>
<H1>Welcome to thebank.co.uk</H1>
<Form action=“http://www.thebank.co.uk/loginprocess.asp” method=
“post”>
Username: <input type=“text” name=“user” size=“20”><br>
Password: <input type=“password” name=“password” size=“20”><br>
<input type=“submit” value=“Submit”>
</Form>
</body>
</html>

The resulting visual display, presented in the browser's viewing pane 16, includes: a heading 17 and a form consisting of two input fields 18A and 18B and a ‘SUBMIT’ button 19.

When a user clicks on the ‘SUBMIT’ button 19, the text entered into the input fields 18A, 18B, is submitted to a second web location 34, which is located by a second URL. This second URL is referred to herein as the Destination-URL.

The action taken by the form 13 is defined by the following line of code:

<Form action=“http://www.thebank.co.uk/loginprocess.asp”method=“post”>,

which defines a URL to which submitted data 24 is posted when the submit button 19 is selected. This third URL is referred to herein as the Stated-URL. In the simple example above, the Stated-URL, given in the code, is the same as the Destination-URL, to which the data 24 are submitted. In more complicated web forms this is not necessarily the case. The Stated-URL may send the data to another section of script within the code, for example, for data validation prior to submitting the credentials to the web location 34 associated with the Destination-URL.

One type of phishing scam attempts to fraudulently acquire credentials from users by mimicking trustworthy websites and luring unsuspecting users into submitting their private credentials to an internet location associated with a phishing site. FIG. 1B shows how a phishing site 30P may mimic the bank website 30 shown in FIG. 1A. The phishing site 30P has a domain name deceptively similar to that of the bank. For example the phishing site 30P of the example has the domain name ‘www.thebank.com’ which is easily confused with the bank's domain name, ‘www.thebank.co.uk’. When a user incorrectly enters the Source-URL, ‘http://www.thebank.com/login.asp’ 15P, into the address bar, the browser downloads the phishing source file 22P from the phishing site's web location 32P.

Phishing scams use a variety of tricks to encourage users to download phishing source files 22P from the phishing site's Source-URL 15P rather than from the genuine URL 15. For example, in a typical scam, an email, purporting to be from the bank, is sent to users requesting that they log into their accounts. A link is provided within the email which directs the user to the phishing site's Source-URL 15P. Alternatively, links may be distributed by instant messaging on telephone networks via SMS (Short Message Service) or the like.

Chat sessions are another channel used for phishing scams. For example, a phisher may pretend to be the representative of a service provider in order to tempt a correspondent to visit the phishing site or to provide credentials such as name, social security number and so on.

Another method for stealing sensitive information is to include hidden fields with typical names such as ‘credit card’ in an otherwise ‘Innocent’ looking form that only request typical information such as the user name and mail address. Since most browsers (and some add on tools) provide functionality to automatically fill web forms with frequently used data (such as name, address, credit card information etc.) those tools may automatically complete the hidden fields with the sensitive information without the user knowledge or consent. The contents of such hidden fields will be sent in the submitted form to the phishing site.

The visual display constructed in the browser's viewing pane 16 using the phishing file 22P is generally similar to and may be visually identical to that constructed using the genuine file 22 from the bank. Although a different Source-URL 15P generally appears in the address bar 14, most users do not notice this. The unsuspecting user is therefore likely to enter credentials into the form and to submit them, believing that they are being submitted to bank's website 30. However the credentials are actually sent by the form in the phishing file 22P, to the Destination-URL, ‘http://www.thebank.com/loginprocess.asp’, which is different from the Destination-URL of the bank's file 22. In this manner, the credentials are submitted to a web location 34P associated with the phishing site 30P.

Known systems for protecting users from phishing attacks typically compare the Source-URL being accessed by a browser with a blacklist of suspect Phishing sites. When a user tries to access a URL associated with a site which is included in the blacklist, the site may be blocked or a warning may be displayed to the user, for example.

Such blacklists are maintained in databases, which may be stored locally on the computer or remotely at some internet location, accessed automatically by the computer and updated regularly. Nevertheless, it will be appreciated that blacklist systems are not fail-safe. New phishing scams are continually being introduced which operate from new phishing sites. There is an inevitable time lag between the introduction of a new phishing site and it being blacklisted and users may falsely submit credentials during this delay period.

There is a need for additional/improved systems for protecting users from phishing scams and embodiments of the present invention addresses this need.

### SUMMARY OF THE INVENTION

It is therefore an object of the present invention to provide a system for preventing at least one credential from being submitted to an unauthorized web location. According to one embodiment of the invention the system comprises a credential blocker for communicating with a database, the database for storing the at least one credential and an associated set of approved URLs; wherein the credential blocker allows submission of the at least one credential only if at least one URL involved with the submission is a member of the associated set.

Typically, the credential is sent from a web form and the URL involved with the submission is selected from the group consisting of: a source-URL, a stated-URL and a destination-URL.

According to some embodiments, the credentials are sent from a communication device. Optionally, the communication device is selected from the group consisting of: computers, personal digital assistants (PDAs), media players, televisions and telephones. The credentials may be sent from a software application selected from the group consisting of: web browsers, instant messengers, email clients, internet browsers, communication applications, web-phones, file transfer systems and video conferencing systems.

Variously, the credential blocker may be further limited by at least one characteristic selected from the group consisting of: the credential blocker comprising a plug-in to a software application, and the credential blocker comprising an add-on software application running on the communication device.

According to further embodiments, the credentials are sent from a software application selected from the group consisting of: web browsers, instant messengers, email clients, internet browsers, communication applications, web-phones, file transfer systems and video conferencing systems.

Preferably, the credential blocker comprises executable code running on at least one remote device. The code may be configured for intercepting a communication from a communication device. Accordingly the remote device may be selected from the group consisting of: a router, a gateway server, a mail server and a proxy server. Additionally, or alternatively, the credential blocker further comprises a user interface for editing the contents of the database.

According to further embodiments of the invention, the database may comprise a storage medium selected from the group consisting of: local applications, remote applications, plug-in applications and add-on applications. Typically, the database is connectable to the internet. Optionally the database may be further limited by at least one characteristic selected from the group consisting of: the database being in communication with a plurality of credential blockers; at least one the associated set comprising one approved URL; the database being editable by a user of the communications device, and the database being editable by representatives of the proprietors of the approved URLs.

Variously, the credential is selected from a group comprising: names, user names, passwords, social security numbers, passport numbers, identification numbers, personal details, telephone numbers, addresses, bank account numbers, credit card numbers and medical details.

Another object of the invention is to teach a method for preventing at least one credential from being submitted to an unauthorized web location, the method comprising the following steps:
Step (a)—populating a database with at least one stored-credential and an associated set of approved URLs;
Step (b)—intercepting a communication to a web location, the communication including a sent-credential;
Step (c)—comparing the sent-credential with the stored-credentials, and
Step (d)—submitting the communication to the web location only if at least one URL involved with the submission is a member of the set of approved URLs associated with the sent-credential.

Optionally, the method also comprises at least one of the additional steps:
Step (e)—notifying a user that the communication has not been submitted if no URL involved with the submission is a member of the set of approved URLs associated with the sent-credential, and
Step (f)—providing a user interface for editing the contents of the database.
According to still other embodiments of the invention the method includes a further step of:
Step (g)—establishing a temporary association between the sent-credential and at least one URL.

It is noted that the temporary association may be removed from the database when at least one of the following conditions is fulfilled:
the sent-credential is submitted more than a threshold number of times;
the sent-credential is submitted more than a number of times defined by the user;
a longer time has past since the temporary association was established than a time limit;
a longer time has past since the temporary association was established than a time limit set by the user, and
an internet browser session is terminated.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

PRIOR ART FIG. 1A schematically shows how a simple web form of the art is accessed by a computer running a web browser;

PRIOR ART FIG. 1B schematically shows how a phishing site as known, may mimic the website shown in FIG. 1A in order to fraudulently obtain credentials from an unsuspecting user;

FIG. 2 is a block diagram showing the main elements of a system for preventing credentials sent by a communication device from being submitted to unauthorized web locations, according to one embodiment of the current invention;

FIG. 3 is a block diagram showing the main elements of another system for preventing credentials entered into a web form associated with an unauthorized web locations from being sent to an unauthorized web location, according to another embodiment of the current invention;

FIG. 4 is a flowchart representing a method for preventing credentials from being submitted to an unauthorized web location, according to an embodiment of the current invention, and

FIG. 5 is a flowchart representing an exemplary method for combating a phishing scam, according to an exemplary embodiment of the invention.

### DESCRIPTION OF THE PREFERRED EMBODIMENTS

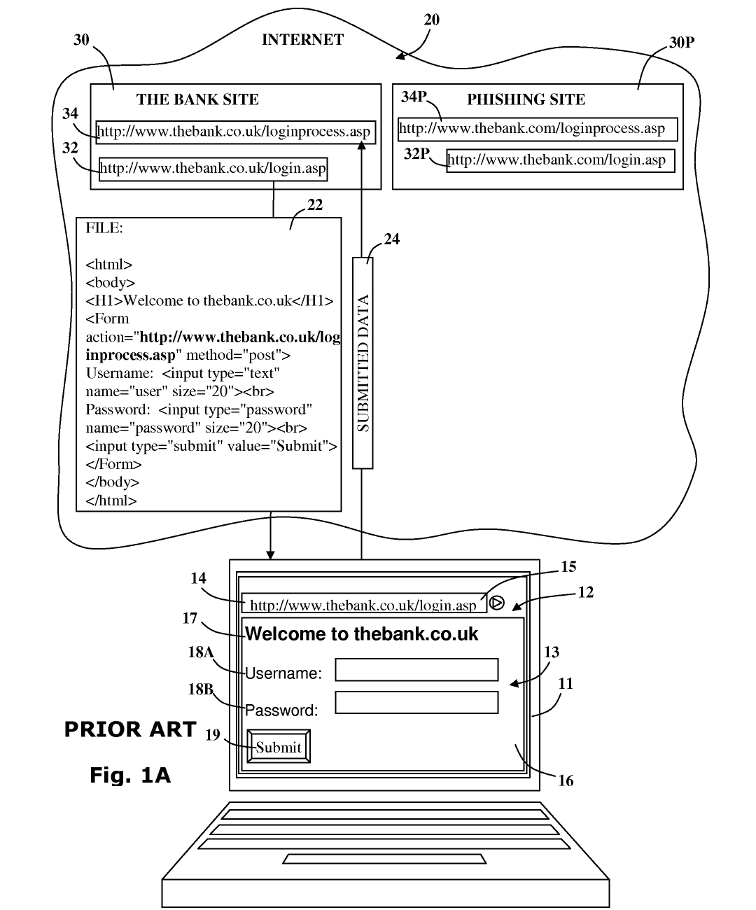

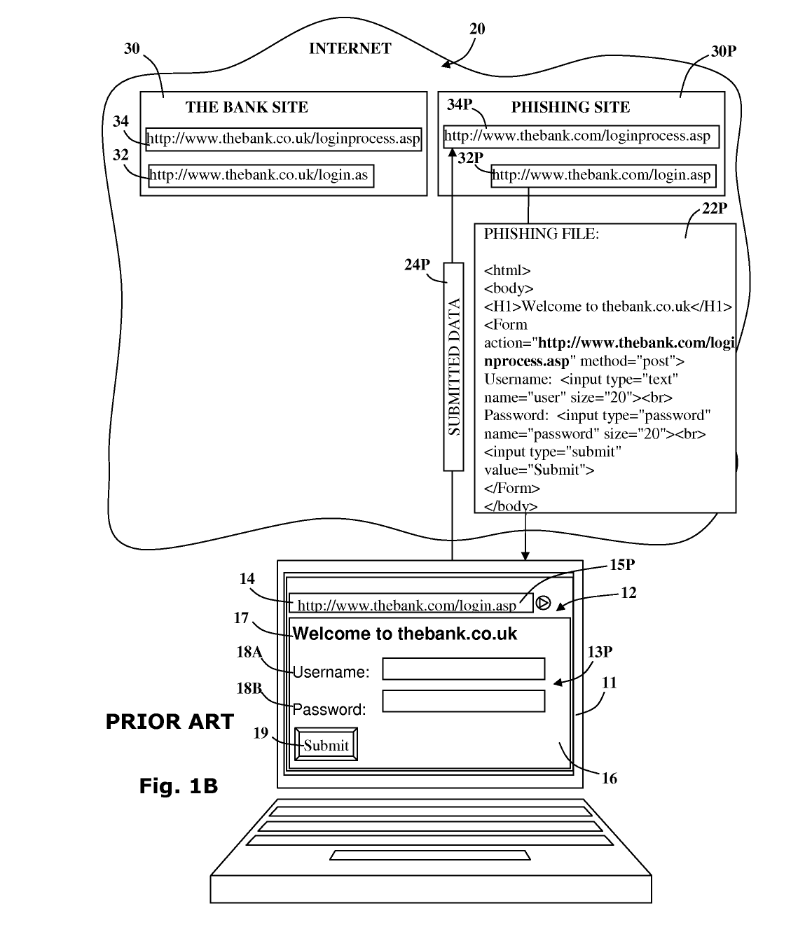

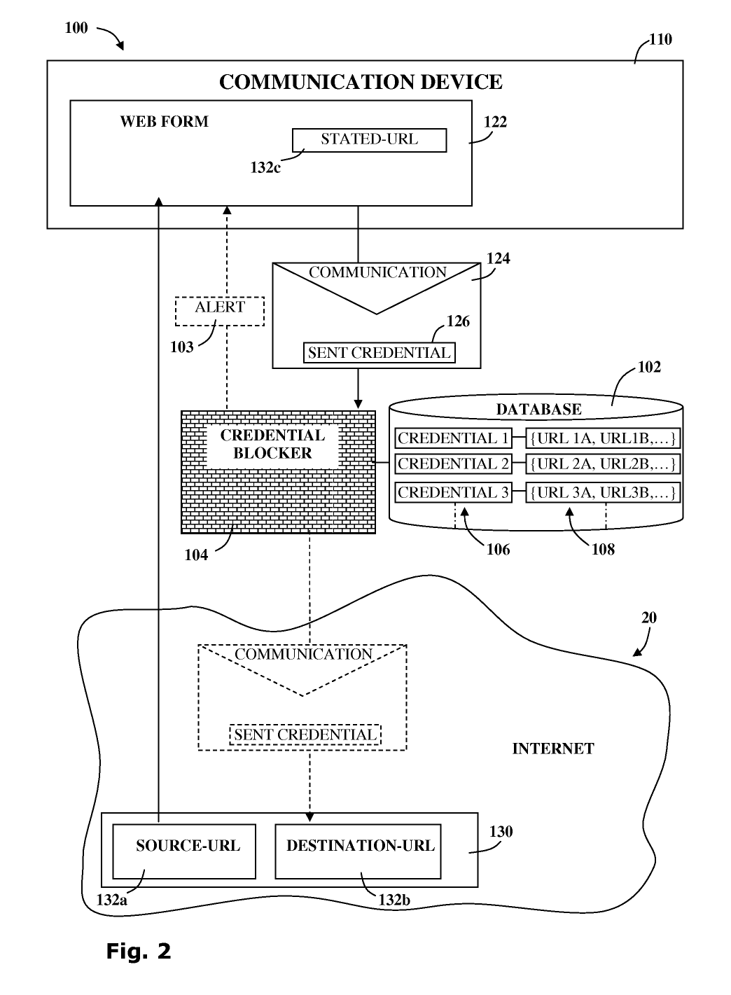

Reference is now made to FIG. 2 showing a block diagram of the main elements of an anti-phishing system 100, according to a first embodiment of the current invention. The anti-phishing system 100 is used to protect a communication device 110, such as a computer, mobile telephone or the like, connected to the internet 20, from submitting private credentials, such as passwords, bank account details and the like, to unauthorized web locations. The anti-phishing system 100 includes a database 102, in the specific example, shown as being external to the communication device 110, and a credential blocker 104.

According to various embodiments, anti-phishing systems 100 are provided to prevent a communication device from submitting personal identification credentials such as names, user names, passwords, social security numbers, passport numbers, identification numbers, personal details, telephone numbers, addresses and the like. In other embodiments the anti-phishing system 100 prevents private information such as bank account numbers, credit card numbers, medical details and the like from being revealed. According to embodiments of the present invention, an attempt to submit such information may be detected before actual submission, and the user may be alerted.

A user of the communication device 110 may send a credential 126 to the internet 20 by entering a credential into a web form 122, downloaded from a source-URL 132a, and uploading the web form 122 to the internet 20. The web form 122 typically includes a stated-URL 132c, determining where a communication 124 containing the credential 126 is posted when the web form 122 is submitted; the sent-credential 126 being directed to a destination-URL 132b.

In embodiments of the current invention, the URLs 132 involved with the submission of the communication 124, such as the source-URL 132a, the destination-URL 132b, the stated-URL 132c or the like, are monitored to ensure that credentials are only sent to authorized web locations. In contradistinction to prior art anti-phishing systems which maintain a database containing the URLs of suspected phishing sites, i.e. a blacklist, embodiments of the current invention maintain a database of approved URLs, i.e. a whitelist.

The database 102 is a storage medium configured to store a plurality of stored-credentials 106. Each stored-credential 106 is paired with an associated set 108 of approved URLs. It is noted that in certain embodiments, the associated sets 108 may include only one member, meaning that a credential 106 may only be submitted to a single web location. For example, where a service provider determines the password rather than the user, it is preferable to allow associating the password with only one URL.

It will be appreciated, that the contents of the database 102 include sensitive credential data. Consequently, in certain embodiments, the stored credentials 106 may be protected, for example by encryption, hashing using a one way function or the like.

In some embodiments, the associated set of URLs may include the URLs of whole web domains. For example, a user with accounts in multiple banks may wish to use the same password for accessing the web site of each bank. In such a case, association with the password may be permitted only to URLs listed in an additional URL list of trusted sites. Optionally this list may be updated from time to time.

The credential blocker 104 includes a carrier medium, such as a gateway server, a mail server, a proxy server or the like, carrying computer readable code for intercepting communications 124, sent from the communications device 110 to the internet 20, which contain sent-credentials 126. The credential blocker 104 is in data communication with the database 102 and is operative to compare the sent-credentials 126 with the stored-credentials 106. Where a sent-credential 126 corresponds to a stored-credential 106, the communication 124 is only submitted if at least one URL 132 involved with the submission is a member of the associated-set 108 paired with the corresponding stored credential 106.

In selected embodiments, when a communication 124 is blocked, an alert 103 is displayed to the user. Such an alert 103 may include a message that the web form 122 has not been sent and may further provide a warning that the website 130 from which the web form 122 was downloaded is an unknown or untrusted site. In other embodiments, the alert 103 may include an interface allowing a user to edit the database 102. A user may thereby update the set 108 of authorized URLs associated with a given credential 106. In particular, when an unlisted credential having no prior associated set of authorized URLs is detected, the user is given the opportunity to add a new associated set to the database, or alternatively to abort the submission. Furthermore, if the credential is already associated in the database with other URLs, the user may have the option to add the current URL (132) to the list of authorized URLs for the credential.

It is appreciated that a proprietor of a single web location may own a plurality of domain names. For example, referring back to FIGS. 1a and 1b, the proprietor of the Bank's web site may own all the domain names: ‘www.thebank.co.uk’, ‘www.thebank.co.ca’ and ‘www.thebank.org’, for example. Conveniently, in some embodiments of the invention the set 108 of approved URLs associated with a given credential may include all URLs related to any of these domain names.

According to other embodiments the database 102 is itself connected to the internet 20. Optionally, the proprietors of URLs approved for a given credential 106, or their representatives, may have limited access to the database 102, and permission to edit the contents of associated sets 108 of which their own URL is a member.

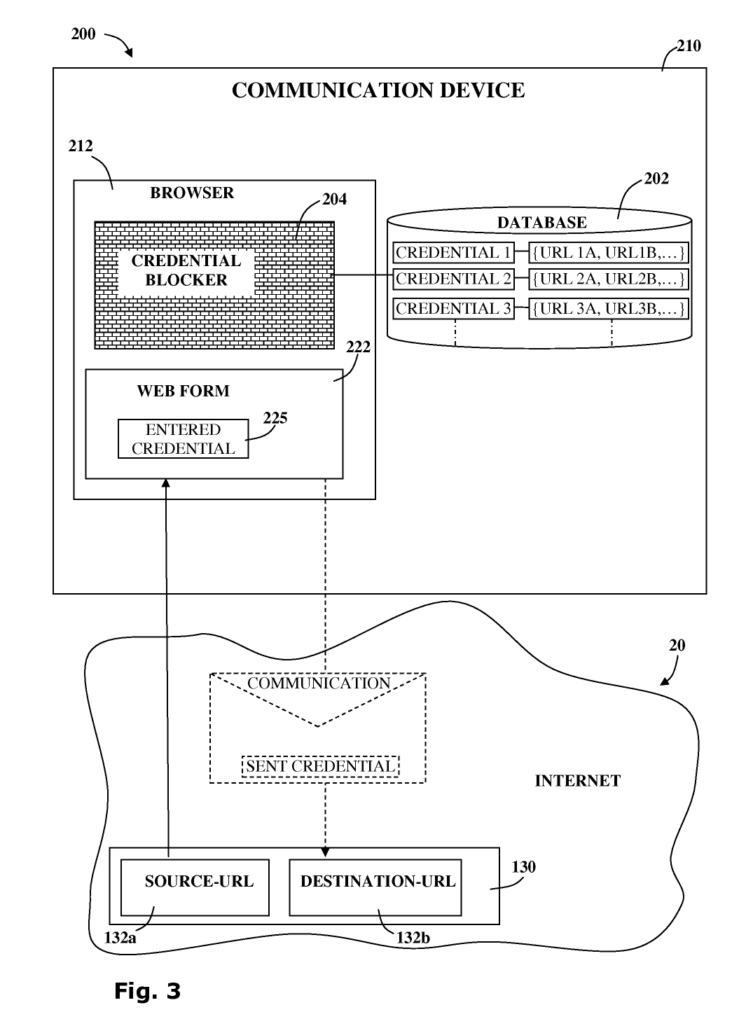

Referring now to FIG. 3, a block diagram is shown of a second anti-phishing system 200 according to an alternative embodiment of the current invention In contradistinction to the anti-phishing system 100 described hereinabove with reference to FIG. 2, the credential blocker 204 of the second anti-phishing system 200 (FIG. 3) is stored on the communication device 210 itself, as a ‘plug-in’ application to the web browser 212. Optionally, the database 202 may also be stored as a ‘plug-in’ to the web browser 212, alternatively, the credential blocker 204 is configured and operable to communicate with a database 202 application stored on the communication device 210 as a separate ‘add-on’ application. In still other embodiments the database 202 is remotely supported at some other storage facility, such as a gateway server, a mail server, a proxy server, a router or the like. The credential blocker 204 is able to access the database 202 as necessary. In some embodiments, the database 202 is accessible by multiple applications and/or by multiple communications devices. Such plug-in or add-on applications may include features allowing code and definitions to be updated remotely.

The credential blocker plug-in 204, may be additionally configured to monitor entered-credentials 225, as they are entered into a web form 222. In some embodiments, the browser 212 may be configured to alert the user to the possibility that the entered-credential 225 is being entered into an unauthorized web form 222 before that web form 222 is uploaded onto the internet 20.

Although a plug-in credential blocker 204 application for a web browser is described above it will be appreciated that appropriate plug-in credential blocker applications may be provided for other communication applications, such as instant messengers, email clients, web-phones, file transfer systems, video conferencing systems, internet browsers and the like.

Thus anti-phishing systems in accordance with embodiments of the invention are provided for various communication devices connectable to the internet and enabling data entry, including computers, personal digital assistants (PDAs), media players, telephones, televisions and the like.

It will be noted that many cellular telephones allow the execution of software applications as well as browsing the Internet, and other Web applications. Furthermore, it is noted that credentials may also be sent by cellular telephone based communication means, such as SMS (Short Messaging Service) messages, as well as other software applications executed by cellular telephone. A hacker may try to use cellular telephone platforms for phishing. Embodiments of the present invention are directed towards preventing credentials from being submitted to unauthorized web locations from cellular telephone based applications.

A particular embodiment of the invention is directed to protect users operating applications on non-permanent platforms such as upon a shared computer in an internet cafe, for example. It will be appreciated that maintaining a permanent database on such a temporary platform is inherently insecure. Accordingly, in such a situation the user may confirm a temporary association of the URL with a password. The temporary association may be limited by a number of parameters, for example: the usage of the credential may be limited by time, number of uses, number of executions of an application (e.g. during one session of executing a Web browser), and so on.

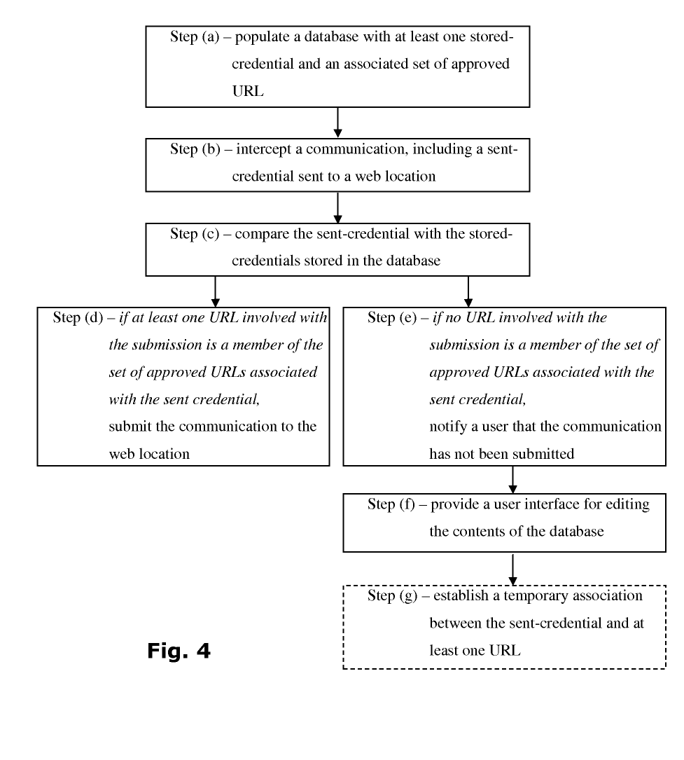

Reference is now made to FIG. 4 showing a flowchart representing a method for preventing credentials from being submitted to an unauthorized web location, in accordance with an embodiment of the current invention. The method includes the following steps:
Step (a)—populating a database with at least one stored-credential and an associated set of approved URLs;
Step (b)—intercepting a communication, including a sent-credential sent to a web location;
Step (c)—comparing the sent-credential with the stored-credentials;
Step (d)—submitting the communication to the web location only if at least one URL involved with the submission is a member of the set of approved URLs associated with the sent credential;
Step (e)—notifying a user that the communication has not been submitted if no URL involved with the submission is a member of the set of approved URLs associated with the sent credential;
Step (f)—providing a user interface for editing the contents of the database, and
Step (g)—optionally, establishing a temporary association between the sent-credential and at least one URL.

The temporary association of step (g) may be limited by a variety of conditions as required. For example, the temporary association may be removed from the database if a sent-credential is submitted more than a given number of times. Optionally, the threshold number of times that a sent-credential is to be submitted may be determined by the user while the temporary association is established. Alternatively, the temporary association may be removed from the database after a time limit, optionally set by the user. In other embodiments, the temporary association is removed when the session of the web application, such as the internet browser, is terminated.

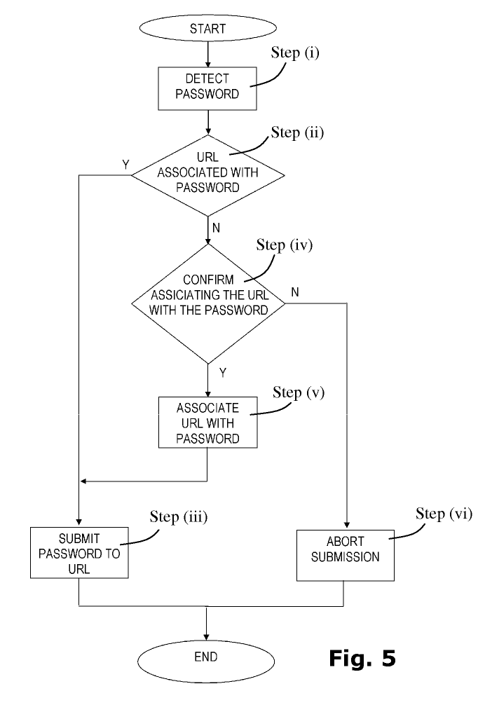

FIG. 5 shows a flowchart schematically illustrating another method for combating a phishing scam, according to an exemplary embodiment of the invention, in which upon attempting to submit data, the data is retrieved and analyzed by a plug-in application executed on a user's computer, such as described above.

In the exemplary method a password is detected in the data to be submitted—step (i). In an HTML page, a password may be detected by its field type (‘Password’ field). Other credential information may also be detected by their relation to other fields. For example, the input field prior to the password field is often the user name/account field. Alternatively, credentials are detected by examining the structure of the supplied credential and matching it to well known structures of specific types of credential information. For example, credit card numbers follow a strict pattern definition and include internal checksum value to verify their correctness.

The system then compares the detected password with contents of the database—step (ii). If one URL involved in the submission is associated with the password, then the data is submitted—step (iii). If the URL is not associated with the password, the user is asked to confirm updating the database by adding a new association between the URL and the password—step (iv). If the user confirms the association, the association is added to the list—step (v), and the submission is performed—step (iii). However, in the event the user does not confirm adding the association, the submission is aborted—step (vi).

It is further noted that in some embodiments the associated URL need not necessarily be identical to a URL from the associated set in order to be trusted, but may demonstrated some correspondence. For example, where the URL involved in the submission differs from the URL from the associated set, but both URLs belong to the same domain, then the URL involved in the submission may be considered as corresponding. For example, URL http://www.thebank.co.uk/login.asp may be considered as corresponding to the URL http://www.thebank.co.uk/login.htm since both refer to the same domain, ‘www.thebank.co.uk’.

In other embodiments, a credential may be defined using meta-data information in an HTML Form (for example in an HTML comment). The meta-data may specify whether a credential is allowed to be used by several URLs or not. The web page may thereby be used to provide directives to an agent application, such as a plug-in or an add-on, as to how to identify a credential and how a credential is to be stored in the database.

The meta-data may further specify that if the same credential is used at another URL, a notification to that effect is sent to a remote location and if the number of such notifications received from a plurality of users exceeds a certain threshold a phishing attack is suspected.

As a further security measure, an HTML form may also include a dedicated field that is filled by the agent application in order to signal that it is installed on the user machine and a web site may deny service to a user if it detects that the agent application is not installed on the user machine. Where appropriate, the contents of the dedicated field may be a key-value generated based on parameters or values which are stored in the HTML form (such as comments, hidden fields etc.). Furthermore, encryption, one way functions and the like may be used in order to prevent the correct key-value of the dedicated field from being guessed.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A system for preventing at least one credential from being submitted to an unauthorized web location, comprising:
a credential blocker for communicating with a database, said database for storing said at least one credential and an associated set of approved URLs; wherein
said credential blocker allows submission of said at least one credential only if at least one URL involved with the submission is a member of said associated set.

2. The system of claim 1, wherein said credential is sent from a web form and said URL involved with the submission is selected from the group consisting of: a source-URL, a stated-URL and a destination-URL.

3. The system of claim 1 wherein said credentials are sent from a communication device.

4. The system of claim 3 wherein said communication device is selected from the group consisting of: computers, personal digital assistants (PDAs), media players, televisions and telephones.

5. The system of claim 3 wherein said credentials are sent from a software application selected from the group consisting of: web browsers, instant messengers, email clients, internet browsers, communication applications, web-phones, file transfer systems and video conferencing systems.

6. The system of claim 3 wherein said credential blocker is further limited by at least one characteristic selected from the group consisting of:
said credential blocker comprising a plug-in to a software application, and
said credential blocker comprising an add-on software application running on said communication device.

7. The system of claim 1 wherein said credentials are sent from a software application selected from the group consisting of: web browsers, instant messengers, email clients, internet browsers, communication applications, web-phones, file transfer systems and video conferencing systems.

8. The system of claim 1 wherein said credential blocker comprises executable code running on at least one remote device, for intercepting a communication from a communication device.

9. The system of claim 8 wherein said at least one remote device is selected from the group consisting of: a router, a gateway server, a mail server and a proxy server.

10. The system of claim 1 wherein said credential blocker further comprises a user interface for editing the contents of said database.

11. The system of claim 1 wherein said database comprises a storage medium selected from the group consisting of: local applications, remote applications, plug-in applications and add-on applications.

12. The system of claim 1 said database being connectable to the internet.

13. The system of claim 1 wherein said database is further limited by at least one characteristic selected from the group consisting of:
said database being in communication with a plurality of credential blockers;
at least one said associated set comprising one approved URL;
said database being editable by a user of said communications device, and
said database being editable by representatives of the proprietors of said approved URLs.

14. The system of claim 1 wherein said credential is selected from a group comprising: names, user names, passwords, social security numbers, passport numbers, identification numbers, personal details, telephone numbers, addresses, bank account numbers, credit card numbers and medical details.

15. A method for preventing at least one credential from being submitted to an unauthorized web location, said method comprising the following steps:
Step (a)—populating a database with at least one stored-credential and an associated set of approved URLs;
Step (b)—intercepting a communication to a web location, said communication including a sent-credential;
Step (c)—comparing said sent-credential with said stored-credentials, and
Step (d)—submitting said communication to said web location only if at least one URL involved with the submission is a member of the set of approved URLs associated with the sent-credential.

16. The method of claim 15 further comprising the additional step of:
Step (e)—notifying a user that said communication has not been submitted if no URL involved with the submission is a member of the set of approved URLs associated with the sent-credential.

17. The method of claim 15 further comprising the additional step of:
Step (f)—providing a user interface for editing the contents of said database.

18. The method of claim 16 further comprising the additional step of:
Step (f)—providing a user interface for editing the contents of said database.

19. The method of claim 15 further comprising the additional step of:
Step (g)—establishing a temporary association between said sent-credential and at least one URL.

20. The method of claim 19 wherein said temporary association is removed from said database when at least one of the following conditions is fulfilled:
said sent-credential is submitted more than a threshold number of times;
said sent-credential is submitted more than a number of times defined by the user;
a longer time has past since said temporary association was established than a time limit;
a longer time has past since said temporary association was established than a time limit set by the user, and
an internet browser session is terminated.
